(19) United States
(12) Patent Application Publication
(10) Pub. No.: US 2007/0016113 A1
(43) Pub. Date: Jan. 18, 2007

(54) Method and device for determining an operating parameter of a shockwave source

(76) Inventors: Gerhard Buchholtz, Erlangen (DE); Jens Fehre, Hausen (DE); Bernd Granz, Oberasbach (DE); Martin Hoheisel, Erlangen (DE); Werner Kruft, Erlangen (DE); Markus Lanski, Furth (DE); Matthias Mahler, Erlangen (DE); Christian Meinert, Marloffstein (DE); Thomas Mertelmeier, Erlangen (DE); Ralf Nanke, Neunkirchen am Brand (DE); Manfred Rattner, Grossenseebach (DE)

Correspondence Address: SCHIFF HARDIN, LLP;PATENT DEPARTMENT, 6600 SEARS TOWER, CHICAGO, IL, 60606-6473, US

(21) Appl. No.: 11/478,824

(22) Filed: Jun. 30, 2006

(30) Foreign Application Priority Data
Jul. 4, 2005 (DE) 10 2005 031 117.2

(51) Int. Cl. A61H 1/00

(52) U.S. Cl. 601/4

(57) ABSTRACT

In a method to determine an operating parameter of a shockwave source for the generation of a shockwave to disintegrate a calculus in a patient by a shockwave lithotripsy, a characteristic of the patient and/or of the calculus is determined before and/or during the shockwave lithotripsy and the operating parameter is automatically determined dependent on the characteristic. A device for determining an operating parameter of a shockwave source for the destruction of a calculus in a patient has an acquisition and control unit for determination and/or input of a characteristic of the patient and/or of the calculus, and for automatic determination of the operating parameter dependent on the characteristic.

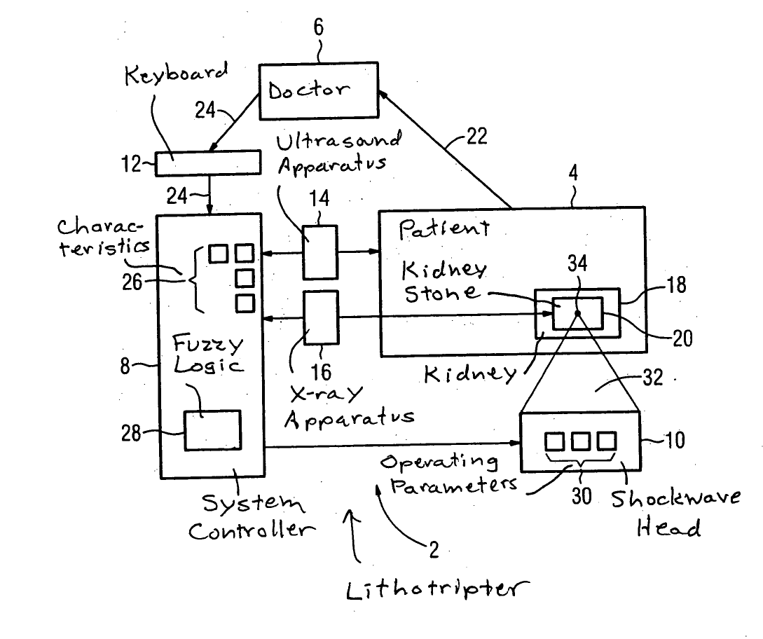

### BACKGROUND OF THE INVENTION

1. Field of the Invention

The present invention concerns a method and a device for determining an operating parameter for a shockwave source for the generation of a shockwave to disintegrate a calculus in a patient by shockwave lithotripsy.

2. Description of the Prior Art

Shockwave lithotripsy is a medical, non-invasive method to disintegrate calculi in patients using ultrasonic shockwaves. Patients are normally living people or animals. Calculi to be destroyed are, for example, kidney, bladder, ureter or gall stones. To treat the patient, a lithotripter is used, the primary component of which is a shockwave source or a shockwave head for generation of ultrasonic shockwave.

Although shockwave lithotripsy is a non-invasive method, unwanted side effects can occur in the patient. These range from pains, to reversible or irreversible damage to tissue that surrounds the calculus, to heart rhythm disruptions. The goal of every shockwave lithotripsy is a greatest possible treatment success, namely freeing the patient of stones without side effects. The treatment success or treatment course or the side effects are hereby dependent on a number of parameters. These are, for example, stone-specific parameters such as the position, size or type of the calculus, patient-specific parameters such as age, kidney function or cardiovascular state of the patient.

Treatment parameters or shockwave parameters such as amplitude, pulse duration or focus geometry of the ultrasonic shockwave as well as the repetition frequency or total number of the shockwaves emitted by the shockwave source, likewise have influence.

Many of these operating parameters of the shockwave source or of the shockwaves are adjustable within certain limits at the lithotripter. Since it is these operating parameters that significantly influence the treatment success of the shockwave lithotripsy and also significantly influence the side effects caused to the patient by the lithotripsy, their careful selection is necessary.

It is therefore necessary to case-specifically adjust the shockwave parameters for each treatment and thus far each combination of stone-specific and patient-specific parameters, necessitating that a large number of influencing variables (which also vary in part during the therapy) be taken into account.

Certain experimental values exist for the selection of the operating parameters, for example for ureter stones a higher shockwave amplitude is normally required than for kidney stones, and for children more conservative (in other words weaker or gentler (more protective) operating parameters must be used than for adults.

The selection of the operating parameters today ensues subjectively by the treating individual, for example the doctor conducting the shockwave lithotripsy, based on the influencing parameters known to him or her and ascertainable by him or her. The treating individual normally uses his or her personal treatment programs that are typical for him or her in the form of a specific combination of operating parameters. The treating individual normally makes this combination only in a somewhat general sense and it is dependent only on the influencing variables that are most important to the treating individual.

A rather inexperienced treating individual familiarizes himself or herself primarily on the application training offered by the manufacturer of the lithotripter, thus the standardized energy levels, shockwave counts etc., and only slowly feels more comfortable in selecting operating parameters that are suitable from his or her point of view that deviate from the standardized values.

Due to the selection of the operating parameters that are strongly subjective, vary from treating individual to treating individual, and are normally less patient-specific or stone-dependent, the optimally achievable treatment course or treatment success for a patient is sometimes not ensured today.

Properties or attributes of the patient or calculus properties that are relevant in such a treatment are known. Specifically for calculi it is known that the chemical composition can be determined from their density and the average atomic number with various x-ray spectra in a computed tomography method (B. J. Heismann et al., J. Appl. Phys. 94(3), 2003, 2073-2079) or from the x-ray absorption (Houndsfield units) in a computed tomography method (P. Joseph et al., J. Urol. 167(5), 2002, 1968-1972. M. S. Ansari et al.). Determination of the crystal structure is possible by x-ray diffraction (Int. Urol. Nephrol. 35(3), 2003, 387-392). The determination of the chemical composition is possible from the grey levels in conventional x-ray exposures (S. Oehlschlager et al., J. Endourol. 17(10), 2003, 841-845) or from the ultrasonic properties (A. Andriulli et al., J. Stone Dis. 5(2), 1993, 96-104).

From RU 2038051 it is furthermore known to establish some operating parameters of a shockwave source before a lithotripsy dependent on the size and structure of the stone, the kidney function and the age of the patient, etc.

Nevertheless, it is always incumbent upon the treating individual to determine which characteristics of the calculus or patient he or she considers relevant before the beginning of the lithotripsy, and which operating parameters he or she adapts to these characteristics. As mentioned above, the treatment course and success must always be customized and dependent on fallible treating individuals.

### SUMMARY OF THE INVENTION

An object of the present invention is to provide an improved method and an improved apparatus for determination of an operating parameter of a shockwave source for shockwave treatment.

With regard to the method, the above object is achieved by a method for determination of an operating parameter of a shockwave source for the generation of a shockwave to disintegrate a calculus in a patient by shockwave lithotripsy, in which a characteristic of the patient and/or of the calculus is determined before and/or during the shockwave lithotripsy, and the operating parameter is automatically determined dependent on the characteristic.

Because the operating parameter is automatically determined dependent on the characteristic, the treating individual or the doctor is relieved from having to select the operating parameter for the shockwave source or the shockwave. The treating individual, moreover, does not have to access the determined characteristic for this purpose. The subjective element in the determination of the operating parameter is thus not a factor due to the automatic determination. For a given characteristic, the determination of the operating parameter is thus reproducible and treatment results are thus comparable.

If the characteristic is also determined during the shockwave lithotripsy and the operating parameter is automatically determined therefrom this, a continuous automatic adaptation or monitoring of the operating parameters occurs in the course of the shockwave lithotripsy. The variation of conditions that led to the selection of the operating parameters or that necessitates their adaptation cannot be forgotten or overlooked by the treating individual.

Dependent on certain characteristics, operating parameters that are effective but still patient-protective are thus safely selected according to known factors. The treating individual can no longer err or misinterpret characteristics in that context.

An advantage for the patient is that the stone destruction is more effective, fewer side effects and complications are to be expected, and the re-treatment rate decreases for this reason. User errors are reduced both for the patient and for the treating individual.

The inventive method is not limited to a single operating parameter nor to a single characteristic. A number of operating parameters thus can be determined and/or a number of characteristics can be determined.

The characteristic and the operating variable can be continuously determined during the shockwave lithotripsy. Primarily due to the continuous implementation of the inventive method during the shockwave lithotripsy it is ensured that in practice operating parameters are checked or updated corresponding to the characteristics at every point in time of the shockwave lithotripsy.

A lithotripsy procedure that is always patient-protective and effective is thus ensured. The total treatment procedure is reproducible.

The characteristic can be determined by means of ultrasound and/or x-rays. Primarily when the characteristic is continuously determined during the shockwave lithotripsy, determination thereof by ultrasound is a particularly patient-protective embodiment. The patient experiences no additional exposure relative to a high x-ray dose, as would be the case for the continuous determination of the characteristic by x-ray radiation.

A wide range of characteristics can be determined as characteristics of the patient and/or of the calculus. The following characteristics are particularly appropriate because they have the greatest influence (according to the present state of knowledge) on the selection of an advantageous operating parameter in shockwave lithotripsy. Such characteristics can be determined individually or in combination in the inventive method.

These characteristics include age of the patient, gender of the patient, chemical and/or bacteriological composition of a body secretion of the patient, position, size, chemical composition, elastic properties and/or crystal structure of the calculus.

A sensitivity value of tissue surrounding the calculus in a patient can also be determined as a characteristic. Damage to tissue of the patient in the surroundings of the calculus (for example of the kidney parenchym surrounding a kidney stone) by shockwaves of course should be avoided. Using such a sensitivity value, the operating parameters can be adapted to the patient such that no injury can occur in the tissue. Given a high sensitivity of the tissue, a particularly tissue-protective combination of the operating parameters of the shockwave thus can be selected. By contrast, given a low sensitivity of relevant tissue, a faster treatment (for example by using higher energy ultrasound shockwaves) can ensue but injury to the tissue can be avoided.

From the sensitivity value, a value range for an operating parameter can be selected such that an injury of the tissue is precluded as long as the operating parameter in question lies in this value range. Due to such limitation of the operating parameter to an allowable value range, freedom is given to the treating individual to select the operating parameters according to his or her own discretion, but at the same time protection is provided for the patient by insuring that the operating parameters do not assume a value that is injurious for the patient. Tissue damage is thus prevented. The tissue of the patient is protected from damage to the best possible extent.

As explained above for the characteristics, a number of selection possibilities that can be selected individually or in combination exist for the operating parameters. Amplitude, pulse duration, repetition frequency, focus geometry of the shockwave as well as total shot number of shockwaves that are specified during shockwave lithotripsy on the patient are suitable as operating parameters that experientially have a large effect on the treatment success, or that should be cautiously adjusted in a known manner in order to avoid injury to the patient. It should be noted, however, that neither the listing of the operating parameters nor the characteristics above is exhaustive.

The position of the focal point of the shockwave can also be determined as an operating parameter. The position and of the focal point and tracking thereof, for example in the center of a calculus or a fragment thereof, is particularly important. Only when the focal point of the ultrasound shockwave is optimally situated in the center of the calculus or fragment to be destroyed is the ultrasonic energy actually utilized in the calculus so as to shatter it as best possible and with as little ultrasonic energy as possible being emitted into the surrounding tissue. The treatment course is thus effective and patient-protective.

The destruction of the calculus can be continued until the calculus and/or its fragments fall below a maximum size. It is then ensured that a post-treatment or re-treatment of the patient with regard to the appertaining calculus is no longer necessary, and the calculus or its fragments can be entirely excreted in a natural manner.

The operating parameter can be determined according to a fuzzy logic algorithm. The known advantages of fuzzy control are particularly suitable for determining a number of operating parameters from a number of characteristics. These advantages include, for example, the simple transfer of expertise in corresponding regulatory or control algorithms.

With regard to the device the object of the invention is achieved by a device for determination of an operating parameter of a shockwave source for the destruction of a calculus in a patient, with an acquisition and control unit to determine and/or input a characteristic of the patient and/or of the calculus, and for automatic determination of the operating parameter dependent on the characteristic.

Due to the acquisition and control unit, the inventive device is suitable to execute the inventive method and thus offers the advantages already explained in connection with the method. For example, by retrofitting, a corresponding acquisition and control unit an existing lithotripter can be converted into an inventive lithotripter.

The device can include an ultrasound device interacting with the acquisition and control unit. Characteristics can be directly or indirectly determined by ultrasound. As mentioned above, a number of successive determinations of the characteristic can be implemented continuously during the shockwave lithotripsy with the use of the ultrasound device. The characteristic thus can be determined continuously and the operating parameters can be continuously determined or adapted from this characteristic. Such an ultrasound device is suitable to function, for example, as an imaging manner in addition to determining the characteristics, so as to supply ultrasound images of the inside of the patient. In addition to determination of the aforementioned characteristics, the treating individual is provided with additional information or image information regarding the patient or the course of the therapy. For example, the degree of destruction or degree of fragmentation of the calculus, or its position and size in the patient, are directly visible in the ultrasound image or are determinable by the acquisition and control unit.

The device can have a fuzzy logic evaluation unit interacting with the acquisition and control unit. Both the characteristics and/or the operating parameters can be determined or established by these units using fuzzy logic algorithms.

Due to the operating parameters of the shockwave head or of the shockwave that are specifically adapted to the calculus and the patient, and primarily due to the dynamic adaptation thereof during lithotripsy dependent on characteristics of the calculus, its effective destruction ensues with few side effects and complications for the patient and a lower re-treatment rate as well as fewer user errors by the treating individual.

In general, how many and which characteristics and operating parameters are determined and adapted before or during the lithotripsy depends on the respective patient or the treatment goal.

### DESCRIPTION OF THE DRAWING

The single FIGURE is a block diagram of a lithotripter in accordance with the invention, illustrating interaction with a doctor and patient during kidney stone lithotripsy.

### DESCRIPTION OF THE PREFERRED EMBODIMENTS

The FIGURE shows a lithotripter 2 with a patient 4 and a doctor 6. The lithotripter has a system controller 8 as an acquisition and control unit. This system controller 8 has a keyboard 12 as an input unit. A shockwave head 10 (controlled by the system controller 8), an ultrasound apparatus 14 and an x-ray apparatus 16 are connected to the system controller 8 in a manner that need not be explained in detail.

A kidney stone 20 that is to be destroyed (disintegrated) by lithotripsy implemented by the doctor 6 exists in a kidney 18 of the patient 4.

Before the beginning of the lithotripsy treatment, the doctor 6 (indicated by the arrow 22) determines the age and gender of the patient 4 and inputs the appertaining values (indicated by the arrow 24) as characteristics 26 into the lithotripter 2 with the keyboard 12 at the lithotripter 2. The characteristics are stored in the system controller 8.

Using the ultrasound apparatus 14, the doctor additionally implements a stone location of the kidney stone 20 in the patient 4. From ultrasound information or ultrasound properties (not shown) of the kidney stone 20, the system controller 8 determines the position, shape, size and chemical composition of said kidney stone 20 as a further characteristics 26. Alternatively or additionally, with the x-ray apparatus 16 the doctor also determines position, size, shape, chemical composition, crystal structure etc. of the kidney stone 20, for example from x-ray spectra, x-ray diffraction, x-ray exposures or computed tomography data (not shown) from the x-ray apparatus 16. Data such as age and gender of the patient can also originate, for example, from an electronic patient record (not shown). For example, the chemical composition of the kidney stone 20 can also be stored therein from an earlier CT examination.

Moreover, a sensitivity parameter of the kidney 18 that surrounds the kidney stone 20 can be determined in the system controller 8 from the aforementioned measurements as a further characteristic 26.

When all of the characteristics 26 have been determined just before the start of the lithotripsy treatment, these are current, and thus applicable for the specific patient 4, such as his or her momentary body position, health state, state of the kidney 18, etc. The characteristics 26 are further processed in the system controller 8. For this purpose the system controller 8 includes, among other things, a fuzzy logic module or fuzzy logic software 28 (for example) containing or having access to stored expert knowledge (not shown) about the logical links and other associations between values of the characteristics 26 and suitable operating parameters 30 of the shockwave head 10. The operating parameters 30 in turn influence the shockwave 32 generated by the shockwave head 10, namely the operating parameters of, for example, its amplitude, pulse duration, repetition frequencies, focus geometry and the total number of emitted shockwaves 32.

The doctor 6 now begins the lithotripsy on the patient 4 by activating the beginning of the lithotripsy in the system controller 8 via the keyboard 12. The operating parameters 30 are transferred from the system controller 8 to the shockwave head 10. From now on, shockwaves 32 are generated by the shockwave head 10 that are focused in the center of the kidney stone 20 (corresponding to the operating parameters 30) and begin to destroy the kidney stone 20.

During the entire lithotripsy, various characteristics 26 or their values (such as, for example, position, size and degree of destruction of the kidney stone 20) are determined by the ultrasound apparatus 14 and/or the x-ray apparatus 16 and the system controller 8, and are compared with the previously-determined values of the corresponding characteristics 26. Possible changed values of the characteristics 26 are converted into operating parameters 30 via the fuzzy logic module or software 28 as described above.

Operating parameters 30 are thus also changed during the lithotripsy if applicable. For example, if the kidney stone 20 shifts within the patient 4, the center point position of the kidney stone 20 as a characteristic 26 thus changes within a stationary coordinate system or a coordinate system attached to the lithotripter. The location of the focal point 34 of the shockwave 32 is thus updated or changed as an operating parameter 30. It is thus ensured during the entire lithotripsy that the focal point 34 is placed in the center of the kidney stone 20. The energy application of the shockwave 32 in the kidney stone 20 is thus as large as possible and the kidney 18 of the patient is protected as is best possible.

Furthermore, during the entire lithotripsy a sensitivity value of the kidney 18 of the patient 4 is determined as an additional characteristic 26. A maximal number of shockwaves 32 is established or is continuously adapted therefrom. The determined maximum number that can be tolerated without risk for the patient is, for example, 3500 shockwaves. It is thus possible for the doctor 6 to exceed the maximum number of 3000 ultrasound shockwaves 32 (normally suggested by the manufacturer) in the patient 4 in order to completely destroy the kidney stone 20 in a single treatment course. No post-treatment and thus no second lithotripsy appointment are necessary for the patient 4.

In the case of a fragmentation of the kidney stone 20, the position and maximal size of the largest still-remaining fragment of the kidney stone 20 is always re-determined as a characteristic 26. The lithotripsy is continued by the doctor 6 until the maximum size of the corresponding fragment has dropped below a patient-specific value. This value was in turn determined from further characteristics 26 determined at the patient. It is thus ensured that all fragments of the kidney stone 20 are excreted by the patient in a natural manner after the lithotripsy.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for determining an operating parameter of a shockwave source for generation of a shockwave to disintegrate a calculus in a patient by shockwave lithotripsy, said operating parameter influencing said generation of said shockwave, said method comprising the steps of:
at a time selected from the group consisting of before said shockwave lithotripsy and during said shockwave lithotripsy, determining a characteristic of at least one of the patient and the calculus; and
automatically determining said operating parameter dependent on said characteristic and setting said shockwave source to generate said shockwave in said shockwave lithotripsy according to said operating parameter.

2. A method as claimed in claim 1 comprising continuously determining said characteristic during said shockwave lithotripsy and continuously adjusting said operating parameter during said shockwave lithotripsy dependent on said characteristic.

3. A method as claimed in claim 2 comprising determining said characteristic using a detector arrangement selected from the group consisting of an ultrasound apparatus and an x-ray apparatus.

4. A method as claimed in claim 1 comprising determining the age of the patient as said characteristic.

5. A method as claimed in claim 1 comprising determining the gender of the patient as said characteristic.

6. A method as claimed in claim 1 comprising determining a chemical composition of a body secretion of the patient as said characteristic.

7. A method as claimed in claim i comprising determining a bacteriological composition of a body secretion of the patient as said characteristic.

8. A method as claimed in claim 1 comprising determining a position of the calculus in the patient as said characteristic.

9. A method as claimed in claim 1 comprising determining a size of the calculus as said characteristic.

10. A method as claimed in claim 1 comprising determining the chemical composition of the calculus as said characteristic.

11. A method as claimed in claim 1 comprising determining an elastic property of the calculus as said characteristic.

12. A method as claimed in claim 1 comprising determining a crystal structure of the calculus as said characteristic.

13. A method as claimed in claim 1 comprising determining a sensitivity value of tissues surrounding the calculus in the patient as said characteristic.

14. A method as claimed in claim 13 comprising designating a value range for said operating parameter dependent on said sensitivity value that substantially precludes damage to said tissue as long as operating parameter is within said value range.

15. A method as claimed claim in claim 1 comprising determining an amplitude of the shockwave as said operating parameter.

16. A method as claimed in claim 1 comprising determining a pulse duration of the shockwave as said operating parameter.

17. A method as claimed in claim 1 comprising determining a repetition rate of the shockwave as said operating parameter.

18. A method as claimed in claim 1 comprising determining a focus geometry of the shockwave as said operating parameter.

19. A method as claimed in claim 1 comprising determining a total number of shockwaves in said shockwave lithotripsy as said operating parameter.

20. A method as claimed in claim 1 comprising determining a position of a focal point of the shockwave as said operating parameter.

21. A method as claimed in claim 1 comprising continuing disintegration of said calculus until said calculus were fragments thereof has a size below a maximum permissible size.

22. A method as claimed in claim 1 comprising determining said operating parameter according to a fuzzy logic algorithm.

23. A device for determining an operating parameter of a shockwave source for generation of a shockwave to disintegrate a calculus in a patient by shockwave lithotripsy, said device comprising:
an acquisition and control unit having an input to which a characteristic of at least one of the patient and the calculus is supplied; and
said acquisition and control unit including a processor that automatically determines, dependent on the characteristic, an operating parameter for the shockwave source that influences said generation of said shockwave.

24. A device as claimed in claim 23 comprising an ultrasound apparatus connected to said input, said ultrasound apparatus generating information from which said characteristic is determined.

25. A device as claimed in claim 23 comprising a detector adapted to interact with the patient during said shockwave lithotripsy, said detector acquiring information continuously during said shockwave lithotripsy from which said characteristic is continuously determined, and said acquisition and control unit continuously adjusting said operating parameter during said shockwave lithotripsy dependent on said characteristic.

26. A device as claimed in claim 23 wherein said processor determines said operating parameter dependent on said characteristic by fuzzy logic.
